(19) United States
(12) Patent Application Publication
(10) Pub. No.: US 2006/0263565 A1
(43) Pub. Date: Nov. 23, 2006

(54) Continuous pressure sensitive magnetic intermediate assembly

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/151,483

(22) Filed: Jun. 13, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.

(51) Int. Cl. B32B 33/00

(52) U.S. Cl. 428/42.3

(57) ABSTRACT

The present invention relates to a composite intermediate web assembly that is produced by using a substrate having magnetic properties and applying a number of individual sheets in an edge-to-edge configuration. A series of preprinted, discrete sheet segments are individually and sequentially laminated by the use of a pattern of adhesive to the web through the use of a placer mechanism that positions each of the segments on the web in a pre-determined pattern. The segments remain free of attachment to one another. The resulting intermediate assembly can be further processed such as by die cutting to produce individual promotional or communication items.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of composite, intermediate manufacturing systems that are used in the preparation of articles, such as pressure sensitive laminates that may be used in the production of magnetic components and the like. More specifically, the present invention is in the field of magnetic business and marketing communications that are produced in a unique and continuous process. The instant specification includes providing a continuous web of magnetic material and then applying a number of discrete, previously prepared and pre-printed segments over the top of the web to create an intermediate assembly that may be further processed, such as by die cutting, to produce magnetic communications that can be used to convey information or aid in developing or advancing a promotion.

The segments, which represent an area of a sheet of printable stock material, are produced in part, initially from a pre-imaged or pre-printed sheet that is then converted or merged to a roll type of format through use of a placer mechanism. The sheets are printed with high quality graphics or images which are then slit or cut to size to form templates, ribbons, surface elements or segments for the particular application. The segments are then converted to or merged with a continuously advancing web to create a continuous roll format. Then the segments that have been affixed to the web are provided in one or more intermediate configurations to an end user. By using the process of the present invention high quality graphics can be prepared to further enhance the particular offering that is being created. More particularly, the pressure sensitive intermediate of the instant application can be used to create individual, magnetic articles including magnetic novelties having a high or photo quality resolution level such as those about 300 lines per inch or approximately 2500 to 3500 dots per inch or even greater resolution.

### BACKGROUND OF THE INVENTION

Magnetic materials have become increasingly common in the business forms and labels industry. Today's growth of new technology plays a vital role in creating and providing businesses forms, which can be used in a variety of businesses and industries. Magnets may be used in a number of applications, such as for advertising and marketing, coupon redemption, message memos, emergency numbers, business and service references, photographs, rebates, etc.

Magnets have been previously attached to materials and used for purposes of marketing and advertising. Some exemplary prior uses of magnets include calendars, business cards, and frames for photographs, advertising collateral and the like. One example of such a prior art construction is provided in U.S. Pat. No. 5,458,282. The construction includes a solid magnet that is attached to one end of a substrate and placed between end edges of the substrate and before the separation line of the adjoining substrate section. The difficulty associated with such prior art constructions is that this construction is often limited in usage due to the quality of printed substrates that have been married up with the magnetic material. Normally, in producing such pieces a printable web is processed through a multi-station press, for example, a flexographic press, which applies several colors to the web. Then the paper web is joined with the magnetic material and the pieces are cut from the joined web to arrive at the finished product.

Flexography is commonly used today for the printing of decorative items including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc., which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime magnetic market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators which can add to manufacturing costs. In addition, waste can be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as labels and other identifiers, using flexography may then be limited to serving only certain market segments, namely large market segments. Markets that are applicable for this technology segment are generally believed to be those orders for large quantities of several millions of pieces, which potentially leaves the smaller market for such promotional items, e.g. 100 to 1,000,000, unfulfilled or at least not adequately served by currently available technologies due to cost and material thresholds.

Another drawback believed to be associated with flexographic technologies is that the technology may not be able to provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations and instead typically must occur through an off line operation, such as ink jetting, often after the piece has been applied to the container or carton. Alternatively, the ink jetting may be performed directly on the container as part of a separate operation.

Flexographic presses normally have a number of predetermined stations. For example, a four color press may have only four stations that can be used to treat or process the web. Thus, if other stations are to be added, such as a numbering head, the manufacturer likely then has to reduce the number of colors that can be added to the web as one station has been surrendered for the numbering head operation.

Flexographic technology also limits the ability to add personalization to products produced on such presses. This may be particularly desirable in certain market segments such prime products on consumer package goods (“CPG”) which may further enhance the product or service offering by making the product more attractive to prospective purchasers, thereby increasing the appeal to the consumer of the product or service.

Identifiers such as magnetic pieces, labels, business cards or tags may also be readily rendered using desktop equipment. While the resolution may be slightly improved when compared with conventional flexographic technology, speeds of application are significantly reduced as the images are processed in a sheet wise fashion on desktop equipment. This results in only a few sheets per minute being produced as opposed to hundreds of feet per minute that are commonly capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of pieces, but may be useful in creating a few dozen pieces for very small applications such as a small home or small office environment.

What is needed, therefore, is an intermediate pressure sensitive magnetic assembly that can be created on which high quality graphics can be used to produce products for a number of distinct applications and with a high degree of variability. For example, graphics having a resolution in excess of about 150 lines per inch can be produced in an efficient and cost effective manner, such as in a system handling a continuous web of material operating at greater than fifty (50) feet per minute to which discrete segments can be applied. Moreover, a system which can add substantial variability to the product as well as other features, such as embossments, over laminates, variable printing or imaging and the like, would greatly expand the penetration of this form of business communication in the marketplace. The present invention seeks to provide an intermediate assembly that is capable of having a number of different surface configurations, e.g. magnetic pieces, with the possible addition of ancillary elements such as labels, cards, tags, plastics, films and the like. The surface configurations, which will consist of a series of discrete individual elements will each have printing or imaging that includes graphical or resolution quality of about 150 or more lines per inch and preferably more than 300 lines per inch, which is approximately equal to about 2500 to 3500 dots per inch (“DPI”) in order to create a high quality image product that is intended to be aesthetically appealing to the consumer and to more effectively communicate the business message of the application.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process, intermediate assembly or system by which a manufacturer can create high quality printed form product templates in a continuous process with each of the templates or ribbons each having significantly improved graphic resolution that is greater than about 150 lines per inch, preferably greater than about 200 lines per inch and still more preferably about 300 lines per inch, in an efficient and cost effective manner. Through the development of the present system and the creation of the unique intermediate web assembly described in this invention, the manufacturer can now service a particular niche market segment for creating high quality templates in a continuous fashion, such as those ranging from approximately 100 to 1,000,000. While the foregoing market size or segment is a target area of the present invention, it should be appreciated that the invention may be practiced and used to fulfill larger order quantities, such as those of a million or more.

The pressure sensitive intermediate of the present invention is created through a unique sheet to roll process which provides savings when compared with conventional processes such as flexography, specifically through reduced make ready time and generation of waste material and yields a higher image resolution product.

The present invention uses previously prepared individually created sheets, or segments, that have imaging or printing already applied to the sheets, e.g. graphical depictions, before the sheets are provided to the manufacturing press. The printing is provided in pre-defined areas, determined prior to production, to create individual segments that can be used for a number of purposes. The templates or segments are then cut from the sheet and supplied to a feeder mechanism. The templates, sheets, ribbons or segments are then applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

By preparing the intermediate assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment of the present invention, a magnetic pressure sensitive intermediate assembly is described and includes a continuous web of material that has magnetic properties. The web has a width and a length and the web is advanced in a machine direction, the direction in which processing steps will be applied to the web.

A pattern of pressure sensitive adhesive is disposed on the web of material and the pattern of adhesive has a width that is less than the width of the web. The adhesive will preferably be a permanent type pressure sensitive adhesive, although other adhesive types are, of course, suitable for use with this invention, such as removable and repositionable.

Each series of discrete segments has a length and a width, with the width of the segment being at least substantially equal to the width of the web. The segment length is substantially less than the length of the web, and each of the segments is provided with printing or imaging including graphical depictions on at least one face. Each segment is sequentially and individually placed on the web in a machine direction. The segments are provided in a predetermined arrangement over the pattern of pressure sensitive adhesive to form an intermediate magnetic web assembly that has a series of discontinuous pre-printed segments.

The arrangement of the pattern of segments that are applied to the web can include portrait, landscape and combinations thereof to create random arrangements that can be used to accommodate particular job configurations.

The magnetic web that is used in the present invention is preferably processed through the apparatus when the web does not have significant magnetic attractive forces. The web may then be subjected to a magnetizer which will create magnetic attractive forces in the product. Alternatively, the web may be processed while the web is provided with a magnetic charge.

In a further embodiment of the present invention, a magnetic assembly is described and includes a magnetic base substrate, with the substrate having a length and width and first and second faces. A pattern of pressure sensitive adhesive is disposed on the first face of the substrate.

Continuing with a description of the presently described embodiment, a plurality of discrete, preprinted segments is provided. Each segment is individually and sequentially placed on the substrate in a substantial edge-to-edge configuration and over the pattern of adhesive to create a discontinuous surface assembly of individual surface elements that are not connected to one another on the magnetic substrate.

In a yet still further embodiment of the present invention, a pressure sensitive intermediate laminate assembly is provided and includes a web of magnetic material that has first and second longitudinally extending sides and first and second faces. A layer of adhesive is applied to the web on the first face and between the first and second longitudinally extending sides. A series of preprinted sheet segments is provided with each of the sheet segments having first and second faces, first and second transversely extending edges and first and second longitudinally extending sides. Each of the segments is printed with graphical depictions that are provided on at least one face. Each of the segments is placed in a pattern on the web of magnetic material between the first and second longitudinally extending sides to create a magnetic intermediate web assembly that has sequentially placed sheet segments.

Each of the foregoing embodiments may also be modified in a number of ways in order to increase the variability of processing and manufacturing of the web. For example, manufacturing or preparation of the web may include the placement of additional elements on top of each of the segments, with the additional element including labels, cards, coins, tags, chips and combinations thereof.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a side view of the intermediate pressure sensitive magnetic web assembly of the present invention;

FIG. 2 shows a top view of the magnetic web assembly of the present invention demonstrating the variability of the invention and depicting the segments disposed in an edge-to-edge relationship;

FIG. 3 illustrates a further embodiment of the present invention showing the segments disposed in an alternating landscape and portrait arrangement;

FIG. 4 provides a yet still further embodiment of the present invention in which a series of segments having shaped portions both within a surrounding matrix and as individual shaped items; and

FIG. 5 provides an intermediate segment assembly in which a number of segments have been created with the segments having additional items applied to the top of the assembly.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the segments or ribbons applied to the web or individual segments positioned on the web in a particular pattern or arrangement. Pattern as defined herein also is used in connection with the adhesive that is applied to the continuous web.

As used herein the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate which is generally variable or unique and which may change from document to document or segment to segment so as to create a customized message or communication for each recipient. Examples of personalized information may include names, addresses, descriptions, plans, coding, numbering, promotional text, etc., that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc., that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the magnetic assembly to a metal surface or the like. Thus, in accordance with the present invention, the intermediate segment for example, could be subject to die cutting, additional printing, such as through ink jetting, over laminating, coating, embossment, and then applied to the metal surface and the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″11″, 11″×14″, 19″×25″ and other known sheet sizes or may be segments, divisions, strips, etc., of such sheets. For example, a 19″×25″ sheet may be produced with five rows, with each row having six segments, with each segment having dimensions of approximately 3″×4″. In this example, each row for instance may comprise an individual segment or sheet that may be used in practicing the present invention. It should however be understood that the invention is not to be so limited to the foregoing configuration and that any individual pieces or elements may be applied to the web, regardless of whether the piece or element has a regular or irregular shape, and used in connection with this process to produce the intermediate assembly that is described in this application.

As used herein, the term “templates” or “element” refers to a particular size, configuration or arrangement of a piece. For example, if the template or segment is a segment, the segment may have a size of 2″×4″, 1″×2″ and other sizes that may be customarily produced. Likewise, if the piece is a card, the card may have a size ranging from 3″×5″, 2″×4″ or any other suitably sized card. The term templates can be used to refer to segments, ribbons and similar terms.

The term or phrase “pressure sensitive magnet assembly” refers to a construction that utilizes an adhesive, preferably a permanent adhesive to bond a magnetic material to a web or sheet. The web or sheet may be a continuous web or carrier sheet or alternatively may be a pre-printed sheet that is applied over a surface of the magnetic web of material to produce a promotional, marketing of informational magnetic assembly.

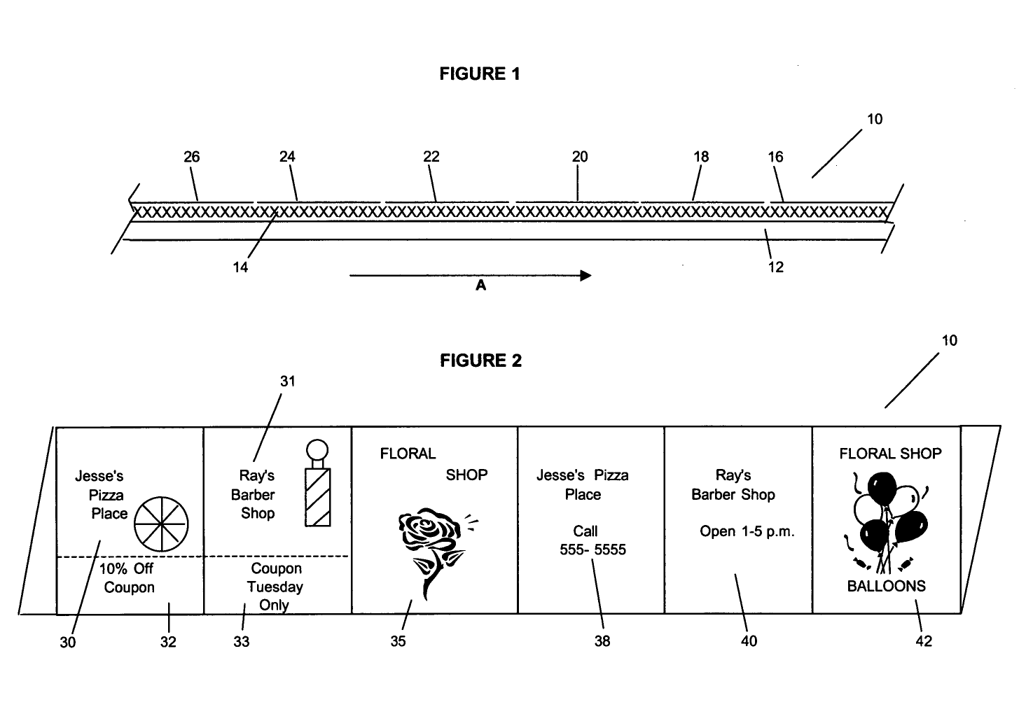

Turning now to FIG. 1 of the present invention, a portion of the continuous web having magnetic properties is shown generally by reference numeral 10. The intermediate web assembly includes a web 12 that has magnetic properties. Preferably, the web will not have a significant magnetic attractive force during the processing so as to facilitate the handling of the web through the equipment. In this embodiment, the web 12 is then subjected to a magnetizer (not shown), available from Ward/Kraft, Inc. of Fort Scott, Kans. that will enhance the magnetic field of the web. Alternatively, the web may have magnetic field that is present. The magnetic web material is available under the name “Plain Brown” from FlexMag of Marietta, Ohio. The web 12 has a width and a length, first and second faces and first and second longitudinally extending sides.

The web 12 has a pattern of pressure sensitive adhesive 14 applied to the surface or first face of the magnetic web 12 and between the first and second longitudinally extending sides. The pattern of adhesive 14 will preferably be applied in a pattern as wide as the web 12 of magnetic material. Alternatively, the adhesive may be applied in various patterns depending on the placement and arrangement of the segments as will be described herein.

FIG. 1 also shows a number of discrete segments, 16, 18, 20, 22, 24 and 26 applied over the adhesive pattern 14 that is on the magnetic web 12. The segments will preferably be permanently affixed to the web via the adhesive, but other adhesives may be used such as repositionable and removable adhesives. Once the segments are affixed to the web 12, the web will generally be collected in its continuous format, such as a roll. However, it should be understood that the web may ultimately be sheeted, or cut into individual segments and/or sheets for later use by a customer or end user.

Attention is now directed to FIG. 2 of the present invention, in which the intermediate assembly, again referenced generally by numeral 10 is shown with a number of segments provided in a portrait arrangement and an edge-to-edge configuration. The application of the templates, sheets, ribbons or segments to the web can be accomplished in a number of patterns, including substantially edge-to-edge configuration that is shown, a slight overlapping arrangement or alternatively, provided in regularly occurring, spaced increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

The intermediate web assembly 10 of FIG. 2 further illustrates the use of variable or personalized imaging that may be accomplished by practicing the present invention. As the segments that are applied to the web are previously prepared by imaging equipment, the sheet and segments that will be cut from the sheet can easily be printed with various permutations of information, including names, addresses, promotional information, seasonal changes and the like.

The segment 30 which will become a separate magnetic element upon severing from the web is divided into first and second portions 30 and 32, with the upper portion including the name of the establishment and the lower portion a coupon offering a particular promotion in connection with the purchase of a product or service. The immediately adjacent segment is again divided into first and second portions 31 and 33 with the upper portion 31 having information relating to a different establishment and the lower portion 33 offering a different promotional coupon. In this example, the variability of the web is demonstrated as distinct segments and can be applied to the magnetic web in any pattern that is desired.

Continuing with the discussion of FIG. 2, the next segment 35 depicts graphical indicia reminiscent of a floral shop as well as containing printed indicia concerning the establishment. Segment 38 has been presented as another magnetic piece that can be used in connection with magnetic segment 30 which allows a customer multiple alternative marketing and business communication pieces in a single run as opposed to having to order a number of one type of communication piece as is normally required from conventional processes.

FIG. 2 also presents segment 40 which contains related indicia to segment 31 and segment 42 which is provided with similar indicia to that shown in segment 35, but this time with a different graphical depiction. The variability of the present invention allows the manufacturer to offer numerous configurations to a single customer without the need to produce multiple runs of product. It should be understood that while these related segments are shown separate from one another,. these segments may be applied adjacent one another or in any other sequence. The segments will ultimately be separated from the web and the related segments assembled for the particular customer or end user.

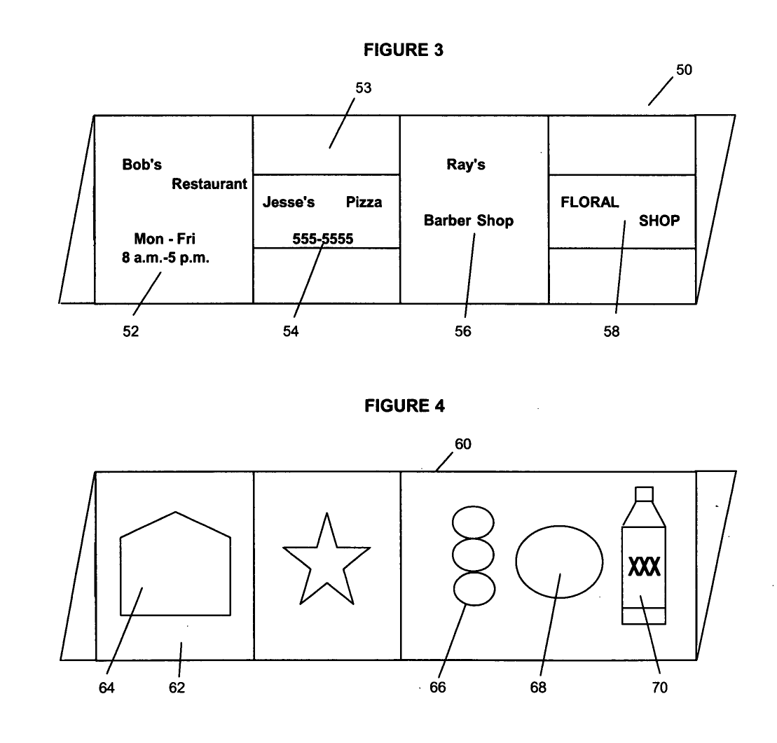

Reference is directed to FIG. 3 of the present invention in which the web 50 is shown with a pattern of segments applied in an alternating portrait and landscape arrangement. Segments 52 and 56 are provided in a portrait configuration while segments 54 and 58 are presented in a landscape configuration. The segments are again provided with variable indicia and the segments vary one from the next in the configuration. It should be understood that the arrangement depicted need not be a regularly repeating arrangement, but that it may also be a random configuration.

In applying the pattern of adhesive to the web, if the full width of the web is coated with adhesive, any exposed adhesive such as in area 53 can be treated so that it is no longer tacky when the web is collected, for instance, in a roll configuration. Alternatively, the areas such as those represented by 53 can be provided with an additional segment disposed, for example, in a landscape configuration.

FIG. 4 of the present invention depicts a yet further embodiment and includes a magnetic web 60 having a series of segments provided with shaped portions both with and without a matrix. Segment 64 includes matrix portion 62. The shaped portion will be the portion that is provided with imaging and will ultimately be die cut from the matrix portion 62 in a down stream operation. Segments 66, 68 and 70 are depicted without matrix portions to demonstrate that odd shaped segments can be deposited on the web and the segments need not have particularly regular appearance.

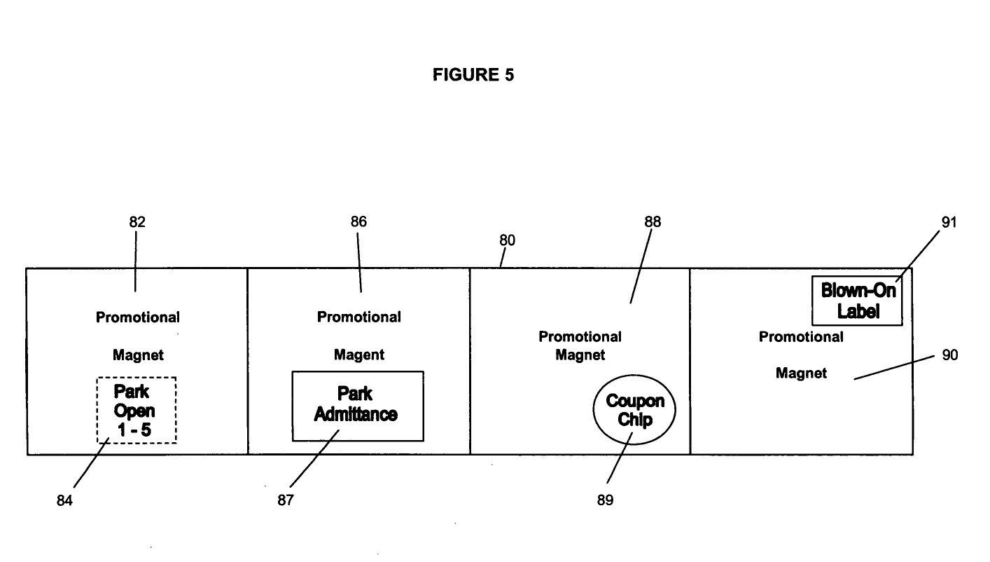

FIG. 5 is used to show a pressure sensitive laminate assembly of the present invention in a sheet configuration and represented by reference numeral 80. The first segment includes a primary area 82 to which promotional indicia has been added. The second portion 84 represents an area that would be beneath an additional element that may be applied over the first segment and which can contain hidden information that is relevant once the additional piece has been removed.

The segment 86 shows a segment to which printing has been applied and a second portion 87 which is a blown on or tipped on card that also may be provided with printing and/or indicia relevant to the printing provided on the segment. Segment 88 along with blown on element 89, here a coupon chip and segment 90 with a blown on piggy back label 91 is also provided on the label web assembly.

Through use of the present invention, a vast array of identifiers, e.g. labels, tags, cards, plates, magnets, etc., can be placed on an adhesive coated web and then collected for later use, thereby creating a versatile pressure sensitive intermediate web assembly. Through the use of the foregoing process, a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional high speed applicators.

One of the most important things with respect to new product innovations is the need to effectively market and communicate the new product to potential customers and end users of the product. Such marketing typically includes the creation of marketing collateral associated with the features of the present method and system and its benefits and uses. These unique products produced by the system and in accordance with the method of the present invention, are sold in connection with that marketing collateral and then distributing the end product to potential end users and customers or transferring the technology to others for incorporation in their respective products. Customers can include distributors of such products as well as office supply stores, retail and warehouse outlets, manufacturers of such products which they themselves may not be end users, but may repackage and resell the products to end users or third parties.

Marketing collateral for communicating business or marketing messages as used herein includes the use of scripted or prepared material that are distributed through audio and visual communication mediums, over a global communication network, or through printed mediums such as newspapers, trade publications, magazines, fliers, handouts and the like.

The present invention further fulfills the need of the small to medium range market for magnetic pieces, those quantities typically between 100 and 1,000,000 without requiring the payment of substantial premiums as may be necessary to offset the costs associated with traditional processes such as flexographic technology.

It will thus be seen according to the present invention a highly advantageous pressure sensitive intermediate magnetic web assembly has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A magnetic pressure sensitive intermediate assembly, comprising;
a continuous web of material having magnetic properties, said web having a width and a length and said web is advanced in a machine direction;
a pattern of pressure sensitive adhesive disposed on said web of material, said pattern of adhesive has a width that is less than said width of said web;
a series of discrete segments having a length and a width, said width of said segment is at least substantially equal to said width of said web and said segment length is substantially less than said length of said web, and each of said segments is provided with printing or imaging including graphical depictions on at least one face; and
wherein each of said segments are sequentially and individually placed on said web in a machine direction in an arrangement and over said pattern of pressure sensitive adhesive to form an intermediate magnetic web assembly having a series of discontinuous pre-printed segments.

2. A magnetic pressure sensitive intermediate assembly as recited in claim 1, wherein said series of discrete segments are provided with shaped portions that may be removed from a surrounding matrix.

3. A magnetic pressure sensitive intermediate assembly as recited in claim 1, wherein said arrangement includes configurations selected from portrait, landscape and combinations thereof.

4. A magnetic pressure sensitive intermediate assembly as recited in claim 1, wherein said segments are provided with variable and personalized indicia.

5. A magnetic pressure sensitive intermediate assembly as recited in claim 1, wherein said web is processed while said magnetic properties have no significant attractive forces.

6. A magnetic pressure sensitive intermediate assembly as recited in claim 1, wherein said segments may be provided in a configuration in which a first segment is provided with a first set of indicia and a successive segment has distinct graphical and textual information and other common indicia related to said first set.

7. A magnetic pressure sensitive intermediate assembly as recited in claim 1, wherein said graphical depiction is produced with a resolution of greater than about 150 lines per inch.

8. A magnetic pressure sensitive intermediate assembly as recited in claim 1, wherein said segments when placed on said web are not adhered to one another.

9. A magnetic assembly, comprising;
a magnetic base substrate, said substrate having a length and width and first and second faces;
a pattern of pressure sensitive adhesive disposed on said first face of said substrate; and
a plurality of discrete, preprinted segments, each of said segments are individually and sequentially placed on said substrate in a substantial edge-to-edge configuration and over said pattern of adhesive to create a discontinuous surface assembly of individual surface elements that are not connected to one another on said magnetic substrate.

10. A magnetic assembly as recited in claim 9, wherein said preprinted segments are placed in an arrangement on said web including portrait, landscape and combinations thereof.

11. A magnetic assembly as recited in claim 9, wherein said substantial edge-to-edge configuration includes a configuration ranging from slightly overlapping to slightly spaced from one another to combinations thereof.

12. A magnetic assembly as recited in claim 9, wherein said segments are provided with graphical depictions and said graphical depictions are produced with a resolution of greater than about 150 lines per inch.

13. A magnetic assembly as recited in claim 9, wherein said segments are permanently adhered to said web by said adhesive.

14. A pressure sensitive intermediate laminate assembly, comprising;
a web of magnetic material having first and second longitudinally extending sides and first and second faces;
a layer of adhesive applied to said web on said first face and between said first and second longitudinally extending sides;
a series of preprinted sheet segments, each of said sheet segments having first and second faces, first and second transversely extending edges and first and second longitudinally extending sides, each of said segments having graphical depictions provided on at least one face; and
wherein, each of said segments is placed in a pattern on said web of magnetic material between said first and second longitudinally extending sides to create a magnetic intermediate web assembly having sequentially placed sheet segments.

15. A pressure sensitive intermediate laminate assembly as recited in claim 14, wherein said pattern includes placing each of said sheet segments in a landscape arrangement on said web of magnetic material.

16. A pressure sensitive intermediate laminate assembly as recited in claim 14, wherein said pattern includes placing each of said sheet segments in a portrait arrangement on said web of magnetic material.

17. A pressure sensitive intermediate laminate assembly as recited in claim 14, wherein said pattern includes placing each of said sheet segments in a random arrangement on said web of magnetic material including both landscape and portrait configurations.

18. A pressure sensitive intermediate laminate assembly as recited in claim 14, wherein said width of each of said sheet segments is substantially equal to said width of said magnetic web.

19. A pressure sensitive intermediate laminate assembly as recited in claim 14, wherein said graphical depiction is produced with a resolution of greater than about 150 lines per inch.

20. A pressure sensitive intermediate laminate assembly as recited in claim 14, wherein said assembly further includes an additional element that is deposited on said segment and said additional element is selected from labels, cards, coins, tags, chips and combinations thereof.
